(19) United States
(12) Patent Application Publication
(10) Pub. No.: US 2025/0220606 A1
(43) Pub. Date: Jul. 3, 2025

(54) Method And Apparatus For Determining Channel Information Based On Synchronization Signal In Mobile Communications

(71) Applicant: MediaTek Inc., Hsinchu City (TW)

(72) Inventors: Tai-Cheng Tsai, Hsinchu City (TW); Cheng-Hsun Li, Hsinchu City (TW); Yi-Ju Liao, Hsinchu City (TW); Wei-De Wu, Hsinchu City (TW)

(21) Appl. No.: 19/004,351

(22) Filed: Dec. 29, 2024

Related U.S. Application Data
(60) Provisional application No. 63/615,355, filed on Dec. 28, 2023.

(51) Int. Cl. H04W 56/00; H04B 17/318; H04L 27/26

(52) U.S. Cl. CPC H04W 56/0015; H04B 17/328; H04L 27/2607

(57) ABSTRACT

Various solutions for determining a channel information based on synchronization signal with respect to an apparatus in mobile communications are described. The apparatus may receive a synchronization signal. The apparatus may decode the synchronization signal based on a cyclic shifted sequence generated by cyclically shifting a root sequence. The root sequence may include a plurality of non-zero values and a plurality of zero values, and any two different cyclic shifted sequences generated from the root sequence may have at most one coincidence of positions of the plurality of non-zero values. The apparatus may determine a channel information based on the synchronization signal.

### CROSS REFERENCE TO RELATED PATENT APPLICATION(S)

The present disclosure is part of a non-provisional application claiming the priority benefit of U.S. Patent Application No. 63/615,355, filed 28 Dec. 2023, the contents of which herein being incorporated by reference in its entirety.

### TECHNICAL FIELD

The present disclosure is generally related to mobile communications and, more particularly, to determining channel information based on synchronization signal with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, synchronization signals are introduced. In particular, synchronization signals may be crucial factors in enabling reliable network operation by supporting timing and frequency synchronization, cell identification, and channel quality measurements. The synchronization signals may assist user equipment (UE) connect to a network, align transmission timing, and maintain signal coherence.

However, detection complexity increases significantly due to factors such as carrier frequency offsets and the need to distinguish between multiple sequences. More specifically, the carrier frequency offsets may cause signal degradation, making synchronization signal detection more challenging. Receivers (e.g., UE) may need to handle a broader range of frequency hypotheses and identify multiple sequences that convey timing, frequency, and cell ID information, increasing detection complexity. In some scenarios, the receivers with low power may have larger clock frequency offsets, which may significantly increase detection complexity, potentially compromising the reliability of synchronization signal detection. Therefore, scheme(s) for detecting synchronization signals with low detection complexity may be developed. Further, based on the new developed scheme(s) for detecting synchronization signals with low detection complexity, channel information associated with the synchronization signals may be correspondingly determined and utilized.

Accordingly, how to decrease detection complexity of the synchronization signals and determine corresponding channel information becomes an important issue in the newly developed wireless communication network. Therefore, there is a need to provide proper schemes to decrease detection complexity of the synchronization signals and determine corresponding channel information.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to determining channel information based on synchronization signal with respect to apparatus in mobile communications.

In one aspect, a method may involve an apparatus receiving a synchronization signal. The method may further involve the apparatus decoding the synchronization signal based on a cyclic shifted sequence generated by cyclically shifting a root sequence. The root sequence may include a plurality of non-zero values and a plurality of zero values, and any two different cyclic shifted sequences generated from the root sequence have at most one coincidence of positions of the plurality of non-zero values. The method may further involve the apparatus determining a channel information based on the synchronization signal.

In one aspect, an apparatus may comprise a transceiver which, during operation, wirelessly communicates with a wireless network. The apparatus may also comprise a processor communicatively coupled to the transceiver. The processor, during operation, may perform operations comprising receiving, via the transceiver, a synchronization signal. The processor may further perform operations comprising decoding the synchronization signal based on a cyclic shifted sequence generated by cyclically shifting a root sequence. The root sequence may include a plurality of non-zero values and a plurality of zero values, and any two different cyclic shifted sequences generated from the root sequence have at most one coincidence of positions of the plurality of non-zero values. The processor may further perform operations comprising determining a channel information based on the synchronization signal.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IloT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIGS. 2A and 2B are diagrams depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a block diagram of an example communication system in accordance with an implementation of the present disclosure.

FIG. 9 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to synchronization signal transmission with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may encode a synchronization signal based on a cyclic shifted sequence generated by cyclically shifting a root sequence. The cyclic shifted sequence may be masked to account for phase rotation with respect to the synchronization signal. The root sequence may include a plurality of non-zero values and a plurality of zero values, and any two different cyclic shifted sequences generated from the root sequence may have at most one coincidence of positions of the plurality of non-zero values. The network node may then transmit the synchronization signal to a user equipment (UE). After receiving the synchronization signal, the UE may decode the synchronization signal based on the cyclic shifted sequence. Accordingly, based on encoding/decoding the synchronization signal by the cyclic shifted sequence of the present disclosure, the detection complexity of the synchronization signals may be significantly reduced.

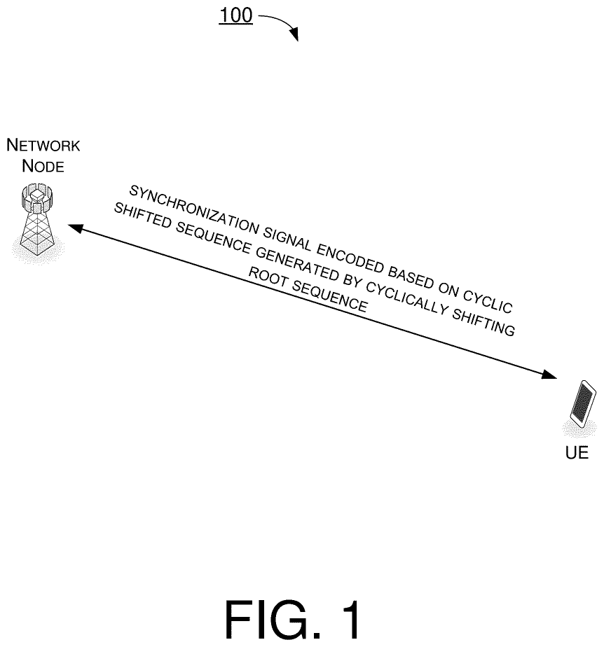

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more network nodes.

In some embodiments, the network node may encode a synchronization signal based on a cyclic shifted sequence generated by cyclically shifting a root sequence. In particular, the root sequence may include a plurality of non-zero values and a plurality of zero values. In some implementations, positions of the non-zero values may be selected to achieve a desired autocorrelation characteristic. For example, the positions of the non-zero values are selected to minimize the number coincidences of positions of non-zero values between the root sequence and a shifted copy (e.g., cyclically shifted or non-cyclically shifted) of the root sequence. Further, the positions of the non-zero values may be selected to achieve an ideal cyclic autocorrelation characteristic. In some examples of the ideal cyclic autocorrelation characteristic, any two different cyclic shifted sequences generated from the root sequence may have at most one coincidence of positions of the plurality of non-zero value. In some cases, a density of the positions of the non-zero values in the root sequence may be lower than a threshold (e.g., lower than 0.5), and a power of the root sequence may be boosted (e.g., the non-zero values may be increased) to match a total power with, for example, a related sequence. The related sequence may have the same length (e.g., the total number of positions) as the root sequence, and have non-zero values at all the positions in an example. In some examples, the number P of resource blocks (RBs) for carrying the synchronization signal may be equal to the number of the non-zero values. To fulfill the previously mentioned root sequence requirements, a length L of the root sequence (or corresponding cyclic shifted sequence) may be at least P·(P−1)+1.

It should be noted that, the root sequence may include non-zero values and zero values, which forms what is known as a low density power boosted (LDPB) sequence. The LDPB sequence mat leverage sparse non-zero elements, where the power may be concentrated, to enhance signal detection and reduce interference. By boosting the power at specific points (e.g., specific resource blocks (RBs)), the LDPB sequence may improve efficient synchronization, while maintaining low complexity in processing.

In some implementations, the cyclic shifted sequence may be masked to account for phase rotation with respect to the synchronization signal. In particular, to optimize time domain peak-to-average power ratio (PAPR) with respect to the synchronization signal encoded by the cyclic shifted sequence, the cyclic shifted sequence may be masked before being used to encode the synchronization signal.

More specifically, to reduce PAPR, sequence masking techniques may modify the transmitted synchronization signal to lower peak power levels. In some cases, Selected Mapping (SLM) may be introduced, where multiple versions of the synchronization signal may be generated by multiplying the cyclic shifted sequence with different masks or phase sequences. These phase sequences may be independent or orthogonal, and the version with the lowest PAPR may be selected for transmission. Accordingly, PAPR may be effectively reduced without affecting the transmitted signal, improving the efficiency of power amplifiers by minimizing the signal's peak power demands.

Then, the network node may transmit the synchronization signal to the UE. After receiving the synchronization signal, the UE may decode the synchronization signal based on the cyclic shifted sequence. Accordingly, because the root sequence and the corresponding cyclic shifted sequence may have low density (i.e., these sequences may include sparse non-zero values), low complexity detection to simplify tasks (e.g., cell search, reference symbol received power measurement, synchronization, etc.) and low complexity signal processing in interference cancellation may be achieved. In addition, because the cyclic shifted sequence may be masked to account for phase rotation with respect to the synchronization signal, the time domain PAPR of transmitting synchronization signals encoded by the cyclic shifted sequence may be optimized, which results in improved power amplifier efficiency, reduced distortion, lower costs, extended battery life, and enhanced reliability.

In some implementations, the synchronization signal may include a primary synchronization signal (PSS). In particular, regarding the PSS, the root sequence may be selected from a plurality of candidate root sequences. The cyclic shifted sequence may correspond to a physical identity N_{ID}⁽²⁾ and be generated according to the following formulas:

$${d}_{p s s} ( n ) = {β}_{p s s} x ( n )$$

$$x ( n ) = \{ \begin{matrix}{k}_{p s s}^{{N}_{ID}^{( 2 )}} ( l ) , & if n = {Λ}_{p s s}^{{N}_{ID}^{( 2 )}} ( l ) \\ 0 , & otherwise\end{matrix}$$

$${Λ}_{p s s}^{{N}_{ID}^{( 2 )}} = sort ( ( {Λ}_{p s s} + Δ k * {N}_{ID}^{( 2 )} ) mod L ) in ascending order$$

$$where$$

$${β}_{p s s} = \sqrt{Q}$$

$$L = P \cdot ( P - 1 ) + 1$$

$$0 \leq n < L$$

$$0 \leq l < P$$

In some cases, (1) dₚₛₛ(n) may be a value of (n+1)^{th} position of the cyclic shifted sequence, (2) Q may be a power boosted value associated sequence length (e.g., Q=(X/P) while X is boosted power such as L=133 (sequence length), 144 (L+PBCH gap) or 240 (SSB length including L)), (3) P may be a number of RBs used for the PSS, (4) L may be a length of the cyclic shifted sequence/the root sequence, (5) kₚₛₛ^{N}^{_{ID}}^{⁽²⁾}(l) is (l+1)^{th} element of a set of masking values while the set is the physical identity N_{ID}⁽²⁾ dependent, (6) Λₚₛₛ may be a set of position index of the plurality of non-zero values of the root sequence, (7) Λₚₛₛ^{N}^{_{ID}}^{⁽²⁾} may be a set of shifted and sorted Λₚₛₛ while the set is the physical identity N_{ID}⁽²⁾ dependent, (8) Λₚₛₛ^{N}^{_{ID}}^{⁽²⁾}(l) may be (l+1)th element of Λₚₛₛ^{N}^{_{ID}}^{⁽²⁾}, and (9) Δk may be a cyclic shift for PSS.

In some implementations, the synchronization signal may include a secondary synchronization signal (SSS). In particular, regarding the SSS, the root sequence may be (i+1)^{th} root sequence of a plurality of selected root sequences, and the plurality of selected root sequences may be selected from the plurality of candidate root sequences. The cyclic shifted sequence may correspond to a physical cell identity N_{ID}^{cell} and be generated according to the following formulas:

$${d}_{s s s} ( n ) = {β}_{sss} {x}_{i , j} ( n )$$

$${x}_{i , j} ( n ) = \{ \begin{matrix}{k}_{s s s}^{i} ( l ) & if n = {Λ}_{s s s}^{i , j} ( l ) \\ 0 , & otherwise\end{matrix}$$

$${Λ}_{s s s}^{i , j} = sort ( ( {Λ}_{s s s}^{i} + Δ k * j ) mod L ) in ascending order$$

$$where$$

$${β}_{s s s} = \sqrt{Q}$$

$$i = ⌊ \frac{{N}_{ID}^{c e l l}}{M} ⌋ ,$$

$$j = {N}_{ID}^{c e l l} mod M$$

$$L = P \cdot ( P - 1 ) + 1$$

$$0 \leq n < L$$

$$0 \leq l < P$$

In some cases, (1) dₛₛₛ(n) may be a value of (n+1)^{th} position of the cyclic shifted sequence, (2) Q may be a power boosted value associated sequence length (e.g., Q=(X/P) while X is boosted power such as L=133 (sequence length), 144 (L+PBCH gap) or 240 (SSB length including L)), (3) P may be a number of RBs used for the SSS, (4) L may be a length of the cyclic shifted sequence/the root sequence, (5) N_{ID}^{cell} may be the physical cell identity associated with the physical cell identity group number N_{ID}⁽¹⁾ while N_{ID}^{cell} is equal to 3*N_{ID}⁽¹⁾+N_{ID}⁽²⁾, (6) kₛₛₛⁱ(l) may be (l+1)^{th} element of a set of masking values while the set is (i+1)^{th} root sequence dependent, (7) Λₛₛₛ^{i,j} may be a set of position indexes of the plurality of non-zero values of (i+1)^{th} root sequence, (8) Λₛₛₛ^{i,j} may be a set of shifted and sorted Λₛₛₛⁱ while the set is (i+1)^{th} root sequence dependent, (9) Λₛₛₛ^{i,j}(l) may be (l+1)^{th} element of Λₛₛₛ^{i,j}, (10) Δk may be a cyclic shift for SSS, and (11) M may be a dedicated number [L/Δk] of SSSs per root sequence.

In some examples of NR network, P is 12 (i.e., the number of RBs for carrying PSS and SSS is 12). When P is 12, length L of root sequence or corresponding cyclic shifted sequence(s) is P·(P−1)+1=133. Based on the root sequence requirements of the present disclosure, there are at least 36 candidate root sequences having length 133.

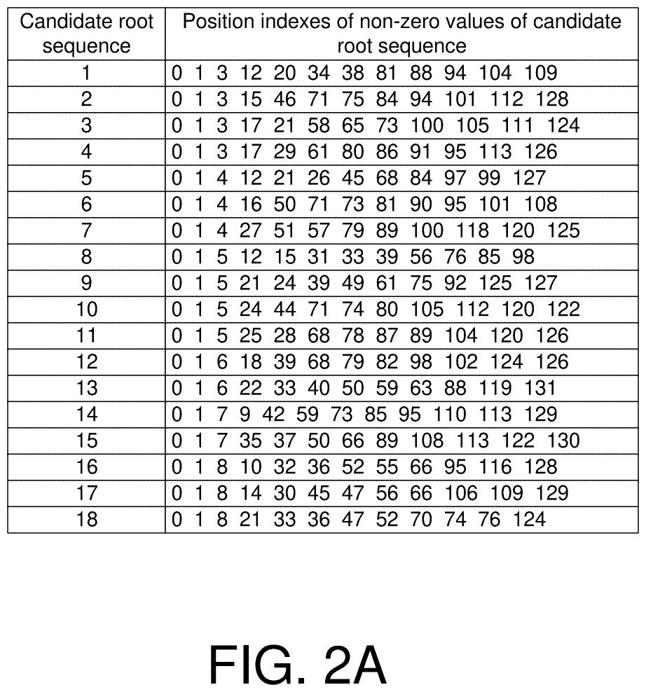

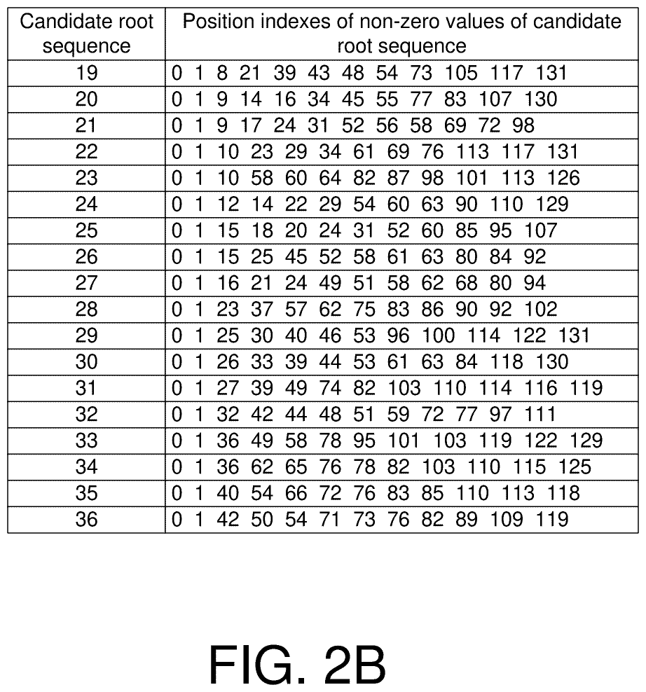

As shown in FIGS. 2A and 2B depicting an example scenario under schemes in accordance with implementations of the present disclosure, for each candidate root sequence, there may be position indexes of non-zero values. For example, position indexes of non-zero values of candidate root sequence 1 are {0 1 3 12 20 34 38 81 88 94 104 109}, which means that 1^{st}, 2^{nd}, 4^{th}, 13^{th}, 21^{th}, 35^{th}, 39^{th}, 82^{th}, 89^{th}, 95^{th}, 105^{th} and 110^{th} positions of candidate root sequence are non-zero values and the rest positions are zero values. For another example, position indexes of non-zero values of candidate root sequence 19 are {0 1 8 21 39 43 48 54 73 105 117 131}, which means that 1^{st}, 2^{nd}, 9^{th}, 22^{th}, 40^{th}, 44^{th}, 49^{th}, 55^{th}, 74^{th}, 106^{th}, 118^{th} and 132^{th} positions of candidate root sequence are non-zero values and the rest positions are zero values

Regarding PSS, there are 3 candidates for carrying the physical identity N_{ID}⁽²⁾: {0, 1, 2}. To accommodate large frequency offsets (e.g., larger than 50 parts per million (ppm) at a carrier frequency of 2.6 GHZ), the cyclic shift Δk is determined as 40 sub-carrier spacing to generate sequence candidates that carry different physical identity N_{ID}⁽²⁾: {0, 1, 2}. When length L of one root sequence is 133 and the cyclic shift Δk is 40, one root sequence can be used to generate at most └L/Δk┘=3 cyclic shifted sequences. Accordingly, 3/3=1 root sequence is selected from 36 candidate root sequences for PSS.

Regarding SSS, there are 1008 candidates for carrying physical cell identity N_{ID}^{cell}, while N_{ID}^{cell}=3*N_{ID}⁽¹⁾+N_{ID}⁽²⁾ and N_{ID}⁽²⁾: {0, 1, . . . 335}. To accommodate moderate frequency offsets (e.g., 2 ppm at a carrier frequency of 2.6 GHZ), the cyclic shift Δk is 3 sub-carrier spacing to generate sequence candidates that carry different physical cell identities N_{ID}^{cell}. When length L of one root sequence is 133 and the cyclic shift Δk is 3, one root sequence can be used to generate at most [L/Δk]=44 cyclic shifted sequences. Accordingly, [1008/44]=23 root sequences are selected from 36 candidate root sequences for SSS.

It should be noted that, in an event that both PSS and SSS are encoded by the cyclic shifted sequences of the present disclosures, 1 root sequence for PSS and 23 root sequences for SSS are selected from 36 candidate root sequences and the total 24 root sequences are different.

Regarding PSS, the cyclic shifted sequence is determined as follows:

$${d}_{p s s} ( n ) = {β}_{p s s} x ( n )$$

$$x ( n ) = \{ \begin{matrix}{k}_{p s s}^{{N}_{ID}^{( 2 )}} ( l ) , & if n = {Λ}_{p s s}^{{N}_{ID}^{( 2 )}} ( l ) \\ 0 , & otherwise\end{matrix}$$

$${Λ}_{p s s}^{{N}_{ID}^{( 2 )}} = sort ( ( {Λ}_{p s s} + 44 * {N}_{ID}^{( 2 )} ) mod 133 ) in ascending order$$

$$where$$

$${β}_{p s s} = \sqrt{12}$$

$$0 \leq n < 133$$

$$0 \leq l < 12$$

In these examples, the root sequence is selected as candidate root sequence 1 of 36 candidate root sequences of table 1 as follows:

$${Λ}_{p s s} = [ \begin{matrix}0 & 1 & 3 & 12 & 20 & 34 & 38 & 81 & 88 & 94 & 104 & 109\end{matrix} ]$$

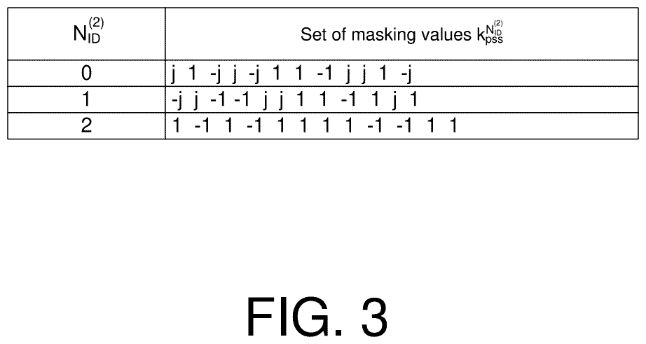

FIG. 3 is a diagram depicting an example scenario under schemes in accordance with implementations of the present disclosure. In these examples, set of masking values, which is physical identity N_{ID}⁽²⁾ dependent, is determined as shown in FIG. 3.

Accordingly, for example, when physical identity N_{ID}⁽²⁾ is ‘0’, non-zero values of 1^{st}, 2^{nd}, 4^{th}, 13^{th}, 21^{th}, 35^{th}, 39^{th}, 82^{th}, 89^{th}, 95^{th}, 105^{th} and 110^{th} positions of the cyclic shifted sequence for PSS are respectively {j 1 −j j −j 1 1 −1 j j 1 −j}.

Regarding SSS, the cyclic shifted sequence is determined as follows:

$${d}_{s s s} ( n ) = {β}_{sss} {x}_{i , j} ( n )$$

$${x}_{i , j} ( n ) = \{ \begin{matrix}{k}_{s s s}^{i} ( l ) & if n = {Λ}_{s s s}^{i , j} ( l ) \\ 0 , & otherwise\end{matrix}$$

$${Λ}_{s s s}^{i , j} = sort ( ( {Λ}_{s s s}^{i} + 3 * j ) mod 133 ) in ascending order$$

$$where$$

$${β}_{s s s} = \sqrt{Q}$$

$$i = ⌊ \frac{{N}_{ID}^{c e l l}}{44} ⌋ ,$$

$$j = {N}_{ID}^{c e l l} mod 44$$

$$0 \leq n < 133$$

$$0 \leq l < 12$$

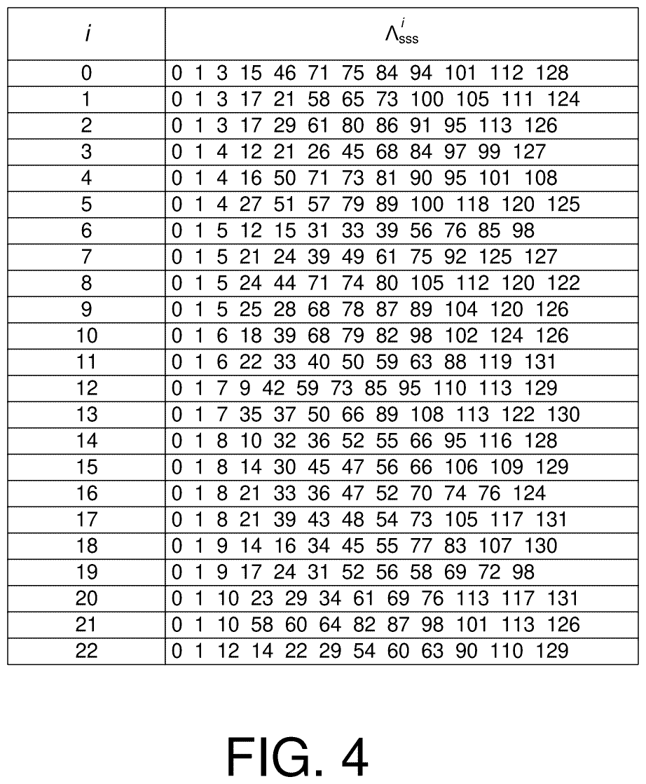

FIG. 4 is a diagram depicting an example scenario under schemes in accordance with implementations of the present disclosure. In these examples, the root sequences are selected as candidate root sequences 2 to 23 of 36 candidate root sequences of table 1 as shown in FIG. 4.

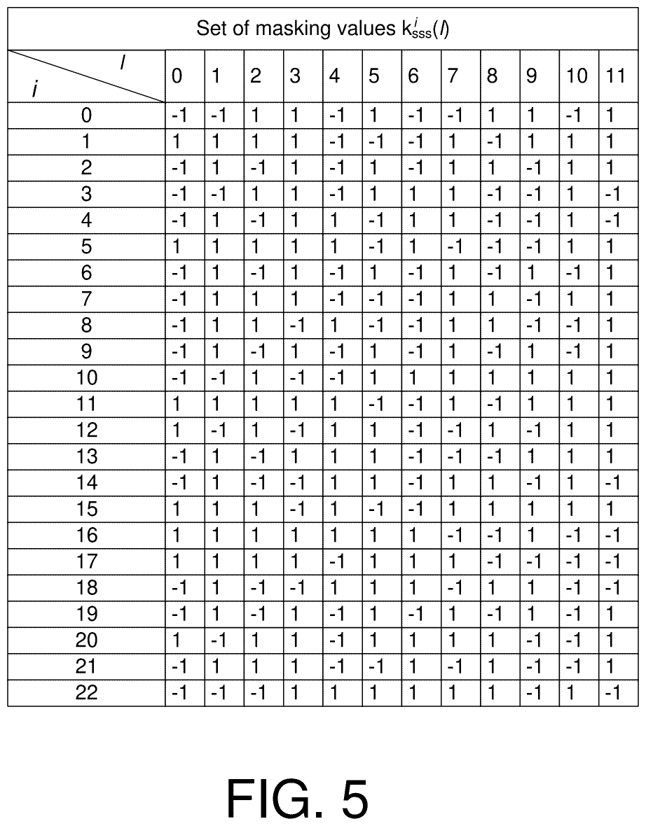

FIG. 5 is a diagram depicting an example scenario under schemes in accordance with implementations of the present disclosure. In these examples, set of masking values kₛₛₛⁱ(l), which is (i+1)^{th} root sequence dependent, is determined as shown in FIG. 5.

Accordingly, for example, when i is ‘0’, set of masking values {−1 −1 1 1 −1 1 −1 −1 1 1 −1 1} is applied to the first selected root sequence {0 1 3 15 46 71 75 84 94 101 112 128} and the corresponding cyclic shifted sequences, which means that: (1) non-zero values of the first selected root sequence for SSS are respectively {−1 −1 1 1 −1 1 −1 −1 1 1 −1 1}, and (2) non-zero values of each cyclic shifted sequence generated from the first selected root sequence are respectively {−1 −1 1 1 −1 1 −1 −1 1 1 −1 1}.

It should be noted that it is not intended to limit the masking values as {1,−1, j,−j} in the present disclosure. The people skilled in the art should easily understand that, to account for different phase rotations with respect to the synchronization signal, the masking values may be adjusted when necessary.

Accordingly, the network node encodes PSS/SSS based on the respective cyclic shifted sequences and transmits PSS/SSS to the UE. After receiving PSS/SSS, the UE decodes PSS/SSS based on the respective cyclic shifted sequences. It should be noted that, the cyclic shifted sequences for PSS and the cyclic shifted sequences for SSS may be calculated in real-time or be pre-stored in the network node and the UE.

In some implementations, the UE may detect and decode the synchronization signal based on the cyclic shifted sequence by at least one operation of segmentation, Fourier transform, energy detection, coarse synchronization and refinement.

In operation of segmentation, the received synchronization signal may be divided into overlapping segments of length N, where N is the length of the cyclic shifted sequence/the root sequence. The length of overlapping between segments may be N/M points. In some cases, parameter M may be degree of overlap between segments. More specifically, when the received synchronization signal is divided into overlapping segments of length N, the overlap between consecutive segments is N/M points. M may be chosen based on factors such as desired synchronization precision, computational limitations, and signal conditions in the UE's operating environment.

In operation of Fourier transform, a length-(N) fast Fourier transform (FFT) may be applied to each segment. This operation may be referred to as partially overlapped sliding discrete Fourier transform (POSD). In some cases, POSD may involve overlapping segments to maintain continuity between the segments, enhancing frequency resolution and mitigating edge effects. Therefore, spectral leakage may be reduced, and synchronization signal detection may be improved, especially in dynamic environments with Doppler shifts or noise. By overlapping segments by N/M points, the sliding FFT may enable more accurate synchronization in mobile systems, ensuring robust performance in high-mobility scenarios while balancing computational efficiency and signal accuracy.

After the FFT, energy detection may be performed by summing the magnitude-squared values of the FFT output at the REs that correspond to the cyclic shifted sequence. This operation may be performed across multiple frequency hypotheses and for each PSS sequence pattern, ensuring robustness against frequency offsets and variations. By focusing on the REs associated with the cyclic shifted sequence, the UE may accurately detect synchronization signals even in noisy or complex environments, facilitating reliable signal acquisition for cell search and handover processes.

In operation of coarse synchronization, the special structure of the cyclic shifted sequence may allow the detection to be performed at a coarse level, such as the OFDM symbol level, which may reduce complexity compared to sample-level detection. This may significantly reduce computational complexity while maintaining synchronization accuracy. By leveraging the periodicity and properties of the cyclic shifted sequence, the UE may quickly achieve initial timing alignment without the need for resource-intensive, sample-by-sample analysis. The coarse synchronization operation may simplify the detection process, enabling more efficient signal acquisition and reducing power consumption, particularly important in high-mobility or resource-constrained network environments.

In operation of refinement, once coarse synchronization is achieved using the reduced-complexity method, the search may be refined with local coherent correlation for more precise synchronization. In some cases, the coherent correlation may involve aligning the received signal with a known reference signal, maximizing the correlation peak to accurately identify the timing and phase of the synchronization signal. The coherent correlation may significantly improve the accuracy of synchronization, enabling precise time and frequency alignment, which is essential for high-quality communication in some networks. The refinement operation may compensate for any residual errors from the coarse stage, ensuring robust synchronization, particularly in challenging conditions like multipath fading or Doppler shifts.

In some embodiments, after decoding the synchronization signal, the UE may determine a channel information based on the synchronization signal.

In some implementations, the channel information may include a first reference symbol received power (RSRP). In particular, the first RSRP may be determined based on a first average power associated with transmission of the synchronization signal based on the plurality of non-zero values and the plurality of zero values. More specifically, the first average power may be determined as follows:

$$= \frac{1}{P} {\sum }_{i ∈ Λ} {\vert {y}_{i} \vert}^{2} - \frac{1}{L - P} {\sum }_{j ∈ {Λ}^{*}} {\vert {y}_{j} \vert}^{2}$$

In some cases, (1) [symbol] may be the first average power, (2) P may be the number of RBs used for the synchronization signal, (3) L may be the length of the cyclic shifted sequence/the root sequence, (4) Λ may be an index set of the plurality of non-zero values while each index indicates a non-zero value, (5) Λ* may be an index set of the plurality of zero values while each index indicates a zero value, (6) yᵢ may be the plurality of non-zero values, and (7) yⱼ may be the plurality of zero values. In other words, the first RSRP may be determined according to the power from REs carrying non-zero values and be adjusted for noise estimated from REs carrying zero values.

In some cases, the first RSRP may be an estimated RSRP with respect to the channel. In some cases, to refine the estimated RSRP, a second RSRP may be introduced. In particular, the second RSRP may be determined based on a second average power associated with transmission of another decoded synchronization signal based on a plurality of non-zero values and a plurality of zero values associated with the another decoded synchronization signal. Then, the UE may an average RSRP based on the first RSRP and the second RSRP while the average RSRP may be the refined RSRP with respect to the channel.

In some cases, the synchronization signal used for determining RSRP may include an SSS.

In some implementations, the channel information may include a magnitude status of the synchronization signal after performing a successive interference cancellation (SIC) associated with the synchronization signal. In particular, in an event that the UE is approaching an edge between a cell (e.g., serving cell) of the network node and a cell (e.g., neighboring cell) of another network nod, the UE may need to handover from the network node to the another network node. Then, the UE may receive another synchronization signal from the another network node for neighboring cell search. More specifically, the UE may perform the SIC by nullifying REs used for carrying the plurality of non-zero values associated with the synchronization signal. Then, the UE may decode the another synchronization signal based on another cyclic shifted sequence after performing the SIC.

In some cases, the REs used for carrying the plurality of non-zero values associated with the synchronization signal may be at least partially overlapped with REs used for carrying a plurality of non-zero values associated with the another synchronization signal.

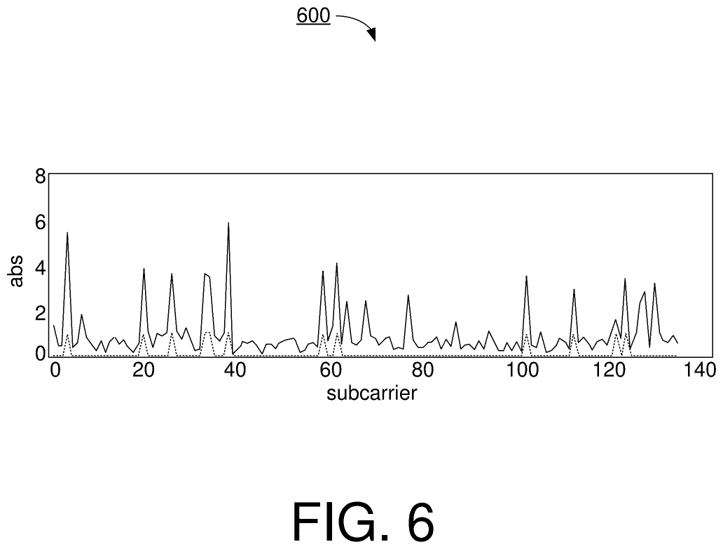

FIG. 6 is a diagram depicting an example scenario 600 under schemes in accordance with implementations of the present disclosure. For example, in FIG. 6, it depicts signal magnitude status before performing SIC. The solid line represents absolute value (abs) of signal magnitude, and the dot line represents indexes (i.e., position indexes of non-zero values of the cyclic shifted sequence) of a strongest signal. In this example, the strongest signal is the received and decoded synchronization signal from the serving cell. Some power peaks of the solid line are determined to be associated with the strongest signal and be indexed (refer to the dot line). Other power peaks on different subcarriers may represent synchronization signals from different cells. SIC is then performed by nullifying REs used for carrying the plurality of non-zero values associated with the strongest signal.

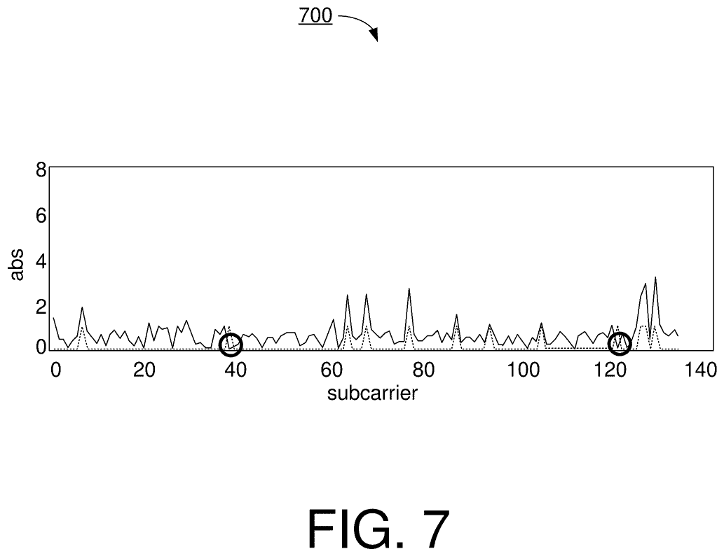

FIG. 7 is a diagram depicting an example scenario 700 under schemes in accordance with implementations of the present disclosure. Further, in FIG. 7, it depicts signal magnitude status after performing SIC. The solid line represents abs of signal magnitude, and the dot line represents indexes (i.e., position indexes of non-zero values of the cyclic shifted sequence) of the second strongest signal. In this example, the second strongest signal is then received synchronization signal from the neighboring cell. After performing SIC to the strongest signal, the second strongest signal is decoded, and some power peaks of the solid line are determined to be associated with the second strongest signal and be indexed (refer to the dot line). Therefore, initialization of neighboring cell search (e.g., for handover from the serving cell to neighboring cell) is achieved.

In this example, the REs used for carrying the plurality of non-zero values associated with the strongest signal are overlapped (refer to circled parts) with REs used for carrying the plurality of non-zero values associated with the second strongest signal. In this situation, nullifying the REs used for carrying the plurality of non-zero values associated with the strongest signal may affect the decoding of the second strongest signal. However, successful decoding of the second strongest signal remains achievable due to the properties of the cyclic shifted sequence/the root sequences of in the present disclosure.

### Illustrative Implementations

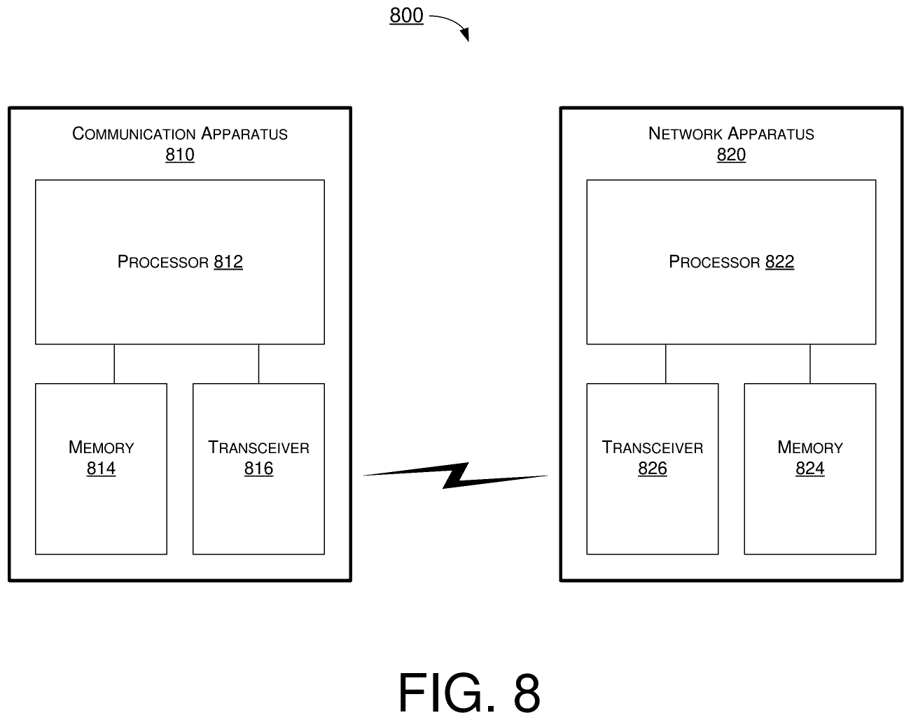

FIG. 8 illustrates an example communication system 800 having an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to determining channel information based on synchronization signal with respect to UE and network apparatus in mobile communications, including scenarios/schemes described above as well as process 900 described below.

Communication apparatus 810 may be a part of an electronic apparatus, which may be a UE such as a portable or mobile apparatus, a wearable apparatus, a wireless communication apparatus or a computing apparatus. For instance, communication apparatus 810 may be implemented in a smartphone, a smartwatch, a personal digital assistant, a digital camera, or a computing equipment such as a tablet computer, a laptop computer or a notebook computer. Communication apparatus 810 may also be a part of a machine type apparatus, which may be an IoT, NB-IoT, or lloT apparatus such as an immobile or a stationary apparatus, a home apparatus, a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example. Communication apparatus 810 may further include one or more other components not pertinent to the proposed scheme of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of a network apparatus, which may be a network node such as a satellite, a base station, a small cell, a router or a gateway. For instance, network apparatus 820 may be implemented in an eNodeB in an LTE network, in a gNB in a 5G/NR, IoT, NB-IoT or lloT network or in a satellite or base station in a 6G network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including determining channel information based on synchronization signal in a device (e.g., as represented by communication apparatus 810) and a network (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In other words, processor 812 may transceive the data such as configuration, message, signal, information, indicator, etc. via transceiver 816. In some implementations, communication apparatus 810 may further include a memory 814 coupled to processor 812 and capable of being accessed by processor 812 and storing data therein. In some implementations, network apparatus 820 may also include a transceiver 826 coupled to processor 822 and capable of wirelessly transmitting and receiving data. In other words, processor 822 may transceive the data such as configuration, message, signal, information, indicator, etc. via transceiver 826. In some implementations, network apparatus 820 may further include a memory 824 coupled to processor 822 and capable of being accessed by processor 822 and storing data therein. Accordingly, communication apparatus 810 and network apparatus 820 may wirelessly communicate with each other via transceiver 816 and transceiver 826, respectively. To aid better understanding, the following description of the operations, functionalities and capabilities of each of communication apparatus 810 and network apparatus 820 is provided in the context of a mobile communication environment in which communication apparatus 810 is implemented in or as a communication apparatus or a UE and network apparatus 820 is implemented in or as a network node of a communication network.

In some implementations, each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

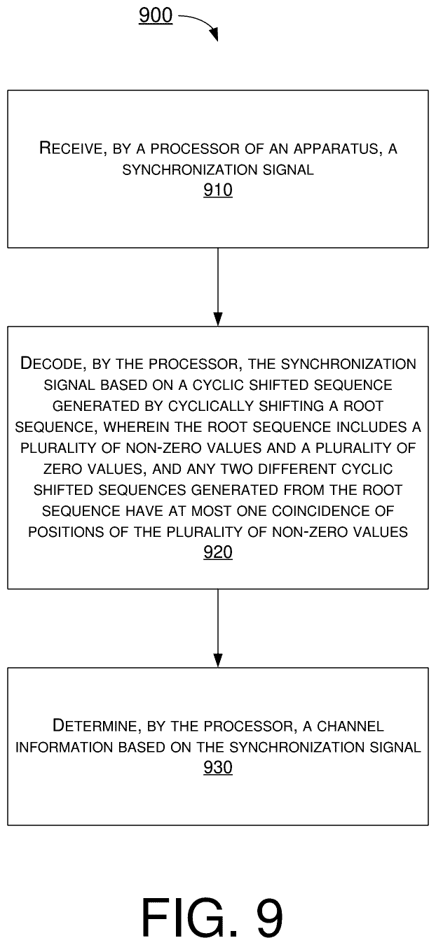

FIG. 9 illustrates an example process 900 in accordance with an implementation of the present disclosure. Process 900 may be an example implementation of above scenarios/schemes, whether partially or completely, with respect to determining channel information based on synchronization signal/of the present disclosure. Process 900 may represent an aspect of implementation of features of communication apparatus 810. Process 900 may include one or more operations, actions, or functions as illustrated by one or more of blocks 910 to 930. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by communication apparatus 810 or any suitable UE or machine type devices. Solely for illustrative purposes and without limitation, process 900 is described below in the context of communication apparatus 810. Process 900 may begin at block 910.

At block 910, process 900 may involve processor 812 of communication apparatus 810 receiving a synchronization signal. Process 900 may proceed from block 910 to block 920.

At block 920, process 900 may involve processor 812 of communication apparatus 810 decoding the synchronization signal based on a cyclic shifted sequence generated by cyclically shifting a root sequence. The root sequence may include a plurality of non-zero values and a plurality of zero values, and any two different cyclic shifted sequences generated from the root sequence may have at most one coincidence of positions of the plurality of non-zero values. Process 900 may proceed from block 920 to block 930.

At block 930, process 900 may involve processor 812 of communication apparatus 810 determining a channel information based on the synchronization signal.

In some implementations, the channel information may include a first RSRP.

In some implementations, process 900 may involve processor 812 of communication apparatus 810 determining the first RSRP based on a first average power associated with transmission of the synchronization signal based on the plurality of non-zero values and the plurality of zero values.

In some implementations, the first average power may be determined based on the following formula:

$$= \frac{1}{P} {\sum }_{i ∈ Λ} {\vert {y}_{i} \vert}^{2} - \frac{1}{L - P} {\sum }_{j ∈ {Λ}^{*}} {\vert {y}_{j} \vert}^{2} ,$$

wherein
[symbol] is the first average power,
P is a number of RBs used for the synchronization signal,
L is a length of the cyclic shifted sequence,
Λ is an index set of the plurality of non-zero values,
Λ* is an index set of the plurality of zero values,
yᵢ is the plurality of non-zero values, and
yⱼ is the plurality of zero values.

In some implementations, the synchronization signal may include an SSS.

In some implementations, process 900 may involve processor 812 of communication apparatus 810 determining a second RSRP based on a second average power associated with transmission of another synchronization signal. Process 900 may involve processor 812 of communication apparatus 810 determining an average RSRP based on the first RSRP and the second RSRP.

In some implementations, the channel information includes a magnitude status of the synchronization signal after performing an SIC associated with the synchronization signal.

In some implementations, process 900 may involve processor 812 of communication apparatus 810 receiving another synchronization signal. Process 900 may involve processor 812 of communication apparatus 810 performing the SIC by nullifying REs used for carrying the plurality of non-zero values associated with the synchronization signal.

In some implementations, the REs used for carrying the plurality of non-zero values associated with the synchronization signal may be at least partially overlapped with REs used for carrying a plurality of non-zero values associated with the another synchronization signal.

In some implementations, process 900 may involve processor 812 of communication apparatus 810 decoding the another synchronization signal based on another cyclic shifted sequence after performing the SIC.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a synchronization signal;
decoding, by the processor, the synchronization signal based on a cyclic shifted sequence generated by cyclically shifting a root sequence, wherein the root sequence includes a plurality of non-zero values and a plurality of zero values, and any two different cyclic shifted sequences generated from the root sequence have at most one coincidence of positions of the plurality of non-zero values; and
determining, by the processor, a channel information based on the synchronization signal.

2. The method of claim 1, wherein the channel information includes a first reference symbol received power (RSRP).

3. The method of claim 2, wherein the step of determining the channel information based on the synchronization signal further comprises:
determining the first RSRP based on a first average power associated with transmission of the synchronization signal based on the plurality of non-zero values and the plurality of zero values.

4. The method of claim 3, wherein the first average power is determined based on the following formula:
$$= \frac{1}{P} {\sum }_{i ∈ Λ} {\vert {y}_{i} \vert}^{2} - \frac{1}{L - P} {\sum }_{j ∈ {Λ}^{*}} {\vert {y}_{j} \vert}^{2} ,$$
wherein [symbol]
is the first average power,
P is a number of resource blocks (RBs) used for the synchronization signal,
L is a length of the cyclic shifted sequence,
Λ is an index set of the plurality of non-zero values,
Λ* is an index set of the plurality of zero values,
yᵢ is the plurality of non-zero values, and
yⱼ is the plurality of zero values.

5. The method of claim 3, wherein the synchronization signal includes a secondary synchronization signal (SSS).

6. The method of claim 3, further comprising:
determining, by the processor, a second RSRP based on a second average power associated with transmission of another synchronization signal; and
determining, by the processor, an average RSRP based on the first RSRP and the second RSRP.

7. The method of claim 1, wherein the channel information includes a magnitude status of the synchronization signal after performing a successive interference cancellation (SIC) associated with the synchronization signal.

8. The method of claim 7, further comprising:
receiving, by the processor, another synchronization signal; and
performing, by the processor, the SIC by nullifying resource elements (REs) used for carrying the plurality of non-zero values associated with the synchronization signal.

9. The method of claim 8, wherein the REs used for carrying the plurality of non-zero values associated with the synchronization signal are at least partially overlapped with REs used for carrying a plurality of non-zero values associated with the another synchronization signal.

10. The method of claim 8, further comprising:
decoding, by the processor, the another synchronization signal based on another cyclic shifted sequence after performing the SIC.

11. An apparatus, comprising:
a transceiver which, during operation, wirelessly communicates with a wireless network; and
a processor communicatively coupled to the transceiver such that, during operation, the processor performs operations comprising:
receiving, via the transceiver, a synchronization signal;
decoding the synchronization signal based on a cyclic shifted sequence generated by cyclically shifting a root sequence, wherein the root sequence includes a plurality of non-zero values and a plurality of zero values, and any two different cyclic shifted sequences generated from the root sequence have at most one coincidence of positions of the plurality of non-zero values; and
determining a channel information based on the synchronization signal.

12. The apparatus of claim 11, wherein the channel information includes a first reference symbol received power (RSRP).

13. The apparatus of claim 12, wherein the operation of determining the channel information based on the synchronization signal further comprises:
determining the first RSRP based on a first average power associated with transmission of the synchronization signal based on the plurality of non-zero values and the plurality of zero values.

14. The apparatus of claim 13, wherein the first average power is determined based on the following formula:
$$= \frac{1}{P} {\sum }_{i ∈ Λ} {\vert {y}_{i} \vert}^{2} - \frac{1}{L - P} {\sum }_{j ∈ {Λ}^{*}} {\vert {y}_{j} \vert}^{2} ,$$
wherein [symbol]
is the first average power,
P is a number of resource blocks (RBs) used for the synchronization signal,
L is a length of the cyclic shifted sequence,
Λ is an index set of the plurality of non-zero values,
Λ* is an index set of the plurality of zero values,
yᵢ is the plurality of non-zero values, and
yⱼ is the plurality of zero values.

15. The apparatus of claim 13, wherein the synchronization signal includes a secondary synchronization signal (SSS).

16. The apparatus of claim 13, wherein the processor further performs operations comprising:
determining a second RSRP based on a second average power associated with transmission of another synchronization signal; and
determining, by the processor, an average RSRP based on the first RSRP and the second RSRP.

17. The apparatus of claim 11, wherein the channel information includes a magnitude status of the synchronization signal after performing a successive interference cancellation (SIC) associated with the synchronization signal.

18. The apparatus of claim 17, wherein the processor further performs operations comprising:
receiving, via the transceiver, another synchronization signal; and
performing the SIC by nullifying resource elements (REs) used for carrying the plurality of non-zero values associated with the synchronization signal.

19. The apparatus of claim 18, wherein the REs used for carrying the plurality of non-zero values associated with the synchronization signal are at least partially overlapped with REs used for carrying a plurality of non-zero values associated with the another synchronization signal.

20. The apparatus of claim 18, wherein the processor further performs operations comprising:
decoding the another synchronization signal based on another cyclic shifted sequence after performing the SIC.
